(19) United States
(12) Patent Application Publication
(10) Pub. No.: US 2025/0238724 A1
(43) Pub. Date: Jul. 24, 2025

(54) COMPUTER-READABLE RECORDING MEDIUM STORING LEARNING PROGRAM, LEARNING METHOD, AND INFORMATION PROCESSING APPARATUS

(71) Applicant: Fujitsu Limited, Kawasaki-shi (JP)

(72) Inventors: Yoshihiro OKAWA, Yokohama (JP); Natsuki ISHIKAWA, Yamato (JP); Masatoshi OGAWA, Zama (JP)

(73) Assignee: Fujitsu Limited, Kawasaki-shi (JP)

(21) Appl. No.: 18/957,941

(22) Filed: Nov. 25, 2024

(30) Foreign Application Priority Data
Jan. 18, 2024 (JP) 2024-006355

(51) Int. Cl. G06N 20/00; H04W 24/08; H04W 64/00

(52) U.S. Cl. CPC G06N 20/00; H04W 24/08; H04W 64/003

(57) ABSTRACT

A non-transitory computer-readable recording medium stores a learning program for causing a computer to execute a process including: calculating, by using a first model that estimates a value of received power of a radio wave received by a communication device from a base station based on position information of the base station and position information of the communication device, an estimated value of the received power of the radio wave; and training a second model that outputs a correction value for correcting the estimated value of the first model based on an actually measured value of the received power of the communication device in an operation environment using the first model, and the estimated value.

### CROSS-REFERENCE TO RELATED APPLICATION

This application is based upon and claims the benefit of priority of the prior Japanese Patent Application No. 2024-6355, filed on Jan. 18, 2024, the entire contents of which are incorporated herein by reference.

### FIELD

The embodiment discussed herein is related to a computer-readable recording medium storing a learning program and the like.

### BACKGROUND

With 5G, high-speed and large-capacity communication may be implemented as compared with 4G.

Japanese Laid-open Patent Publication Nos. 2022-125873 and 2022-075110, and U.S. Patent Application Publication Nos. 2022/0167183 and 2022/0239395 are disclosed as related art.

### SUMMARY

According to an aspect of the embodiments, a non-transitory computer-readable recording medium stores a learning program for causing a computer to execute a process including: calculating, by using a first model that estimates a value of received power of a radio wave received by a communication device from a base station based on position information of the base station and position information of the communication device, an estimated value of the received power of the radio wave; and training a second model that outputs a correction value for correcting the estimated value of the first model based on an actually measured value of the received power of the communication device in an operation environment using the first model, and the estimated value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing processing of collecting actually measured data;

FIG. 2 is a diagram for describing processing of performing learning of a correction model;

FIG. 3 is a diagram for describing processing of creating a propagation model;

FIG. 4 is a diagram for describing processing related to design and learning of a control rule;

FIG. 5 is a functional block diagram illustrating a configuration of an information processing apparatus according to the present embodiment;

FIG. 6 is a flowchart illustrating a processing procedure of the information processing apparatus according to the present embodiment;

FIG. 7 is a diagram illustrating a target area;

FIG. 8 is a diagram (1) illustrating a comparison result between an estimated value by the propagation model and a theoretical value;

FIG. 9 is a diagram (2) illustrating a comparison result between an estimated value by the propagation model and a theoretical value;

FIG. 10 is a diagram (3) illustrating a comparison result between an estimated value by the propagation model and a theoretical value;

FIG. 11 is a diagram (4) illustrating a comparison result between an estimated value by the propagation model and a theoretical value;

FIG. 12 is a diagram illustrating a comparison result of average power consumption of a base station;

FIG. 13 is a diagram illustrating a comparison result of maximum loads of the base station; and

FIG. 14 is a diagram illustrating an example of a hardware configuration of a computer that implements same functions as those of the information processing apparatus according to the present embodiment.

### DESCRIPTION OF EMBODIMENTS

However, it is expected that power consumption of 5G will reach four to nine times that of 4G in the future, and it is desirable to save power while guaranteeing a communication quality from a viewpoint of reducing greenhouse gas emissions and the like.

In order to achieve both the communication quality and power saving, it is desirable to estimate received power of user equipment (UE) based on information on base stations (BSs) and the UEs scattered in various places and to appropriately control the BSs based on the estimation result.

As a technique related to the above, for example, there is a related-art technique in which the received power of the UE is estimated from information on the BSs and the UEs based on an estimation model that has performed learning by machine learning.

With the above-described related-art technique, however, there is a problem in that the estimation model is not capable of accurately estimating received power of a communication device such as a UE, and the received power of the communication device such as the UE is not accurately estimated in an actual operation.

In one aspect, an object of the present disclosure is to provide a computer-readable recording medium storing a learning program, a learning method, and an information processing apparatus for accurately estimating received power of a communication device.

Hereinafter, an embodiment of a learning program, a learning method, and an information processing apparatus disclosed in the present application will be described in detail based on the drawings. This disclosure is not limited by this embodiment.

### EMBODIMENT

An example of processing of an information processing apparatus according to the present embodiment will be described. The information processing apparatus according to the present embodiment is referred to as an “information processing apparatus 100”. For example, the information processing apparatus 100 executes processing of collecting actually measured data, processing of performing learning of a correction model, processing of creating a propagation model, and processing related to design and learning of a control rule.

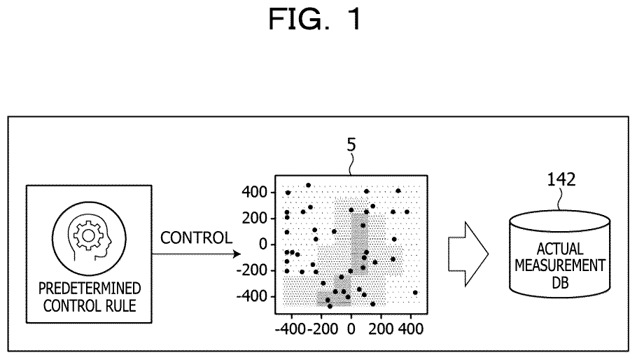

First, an example of the processing of collecting actually measured data will be described. FIG. 1 is a diagram for describing the processing of collecting actually measured data. With a predetermined control rule, the information processing apparatus 100 collects information on a base station (BS) and a communication device (UE) as the “actually measured data” while operating a network in an actual operation environment. The predetermined control rule is a control rule set in advance.

For example, it is assumed that an area corresponding to the actual operation environment is an area 5. The area 5 includes a plurality of base stations and a plurality of communication devices. With the predetermined control rule, the information processing apparatus 100 performs control of switching a radio unit (RU) of each base station to an “active mode” or a “sleep mode”. The actually measured data described above includes position information of each base station, position information of each communication device, received power (information of received power) of each communication device, and the like.

The information processing apparatus 100 may collect the actually measured data by communicating with each base station and each communication device included in the area 5, or may collect the actually measured data via an external server or the like that communicates with each base station and each communication device. At predetermined time intervals, the information processing apparatus 100 collects the actually measured data and stores the collected actually measured data in an actual measurement DB 142.

As the actually measured data, the information processing apparatus 100 may further collect a height at which the base station is installed, power consumption (transmission power) taken for the base station to transmit a radio wave, a frequency of the radio wave, a height of the communication device, and the like.

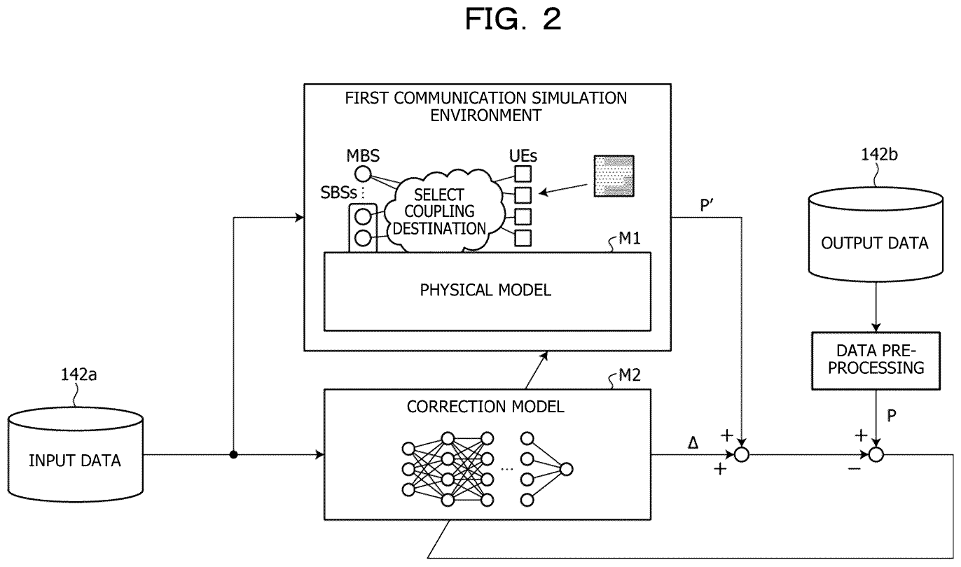

Subsequently, an example of the processing of performing learning (machine learning) of a correction model will be described. FIG. 2 is a diagram for describing the processing of performing learning of the correction model. When performing learning of a correction model M2, the information processing apparatus 100 uses input data 142a, output data 142b, and a physical model M1.

The input data 142a includes position information of the base station and position information of the communication device among the pieces of information included in the actually measured data.

The output data 142b includes received power of the communication device among the pieces of information included in the actually measured data. By executing data pre-processing on the output data 142b, the information processing apparatus 100 calculates an “actually measured value P” of the received power. For example, the information processing apparatus 100 executes data pre-processing such as calculating an average value of received power of a target communication device.

The physical model M1 is a model that estimates received power of the communication device that receives the radio wave of the base station based on a distance attenuation expression or the like of the radio wave in a first communication simulation environment set in advance. The physical model M1 is generated in advance. By inputting the input data 142a to the physical model M1, for example, the information processing apparatus 100 calculates an “estimated value P” of the received power. The physical model M1 corresponds to a “first model”.

The correction model M2 is a model that receives the input data 142a as an input and outputs a correction value A. The correction model M2 is a deep neural network (DNN) or the like. The information processing apparatus 100 updates parameters of the correction model M2 such that a value of “P−(P′+Δ)” approaches 0. By using, for example, a backpropagation method or the like, the information processing apparatus 100 updates the parameters of the correction model M2 (performs machine learning of the correction model M2). The correction model M2 corresponds to a “second model”.

When training of the correction model M2 is executed, the information processing apparatus 100 may further use, as the input data 142a, the height at which the base station is installed, the power consumption (transmission power) taken for the base station to transmit the radio wave, the frequency of the radio wave, the height of the communication device, and the like.

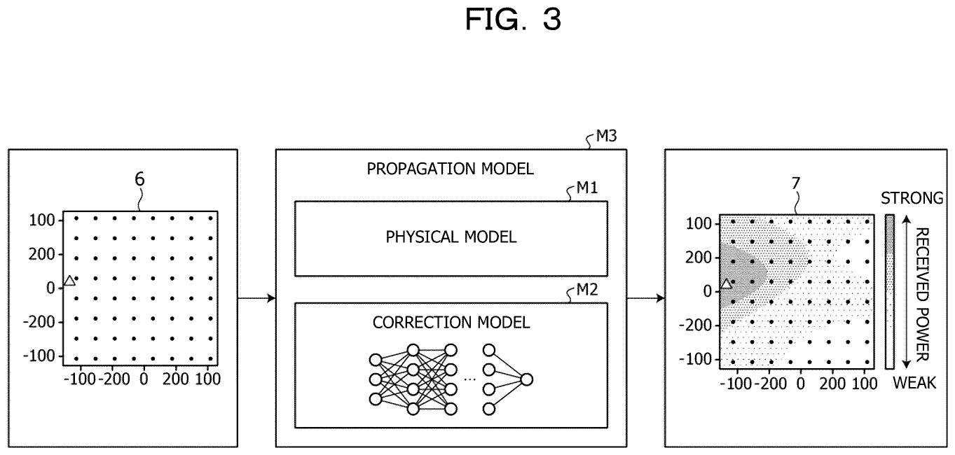

Next, an example of the processing of creating a propagation model will be described. FIG. 3 is a diagram for describing the processing of creating the propagation model. By combining the physical model M1 and the correction model M2, the information processing apparatus 100 creates a propagation model M3, as illustrated in FIG. 3. FIG. 3 illustrates an example of calculating an estimation result 7 of the received power based on input data 6 and the propagation model M3.

The input data 6 includes position information of an arbitrary base station and position information of an arbitrary communication device in the area corresponding to the operation environment. For example, in the input data 6 illustrated in FIG. 3, a triangle indicates a position of the arbitrary base station, and a circle indicates a position of each communication device.

When the information processing apparatus 100 inputs the input data 6 to the propagation model M3, the input data 6 is input to each of the physical model M1 and the correction model M2. When the input data 6 is input, the physical model M1 outputs an estimated value of received power of the arbitrary communication device. When the input data 6 is input, the correction model M2 outputs a correction value of the received power of the arbitrary communication device. The propagation model M3 estimates a result obtained by adding the estimated value output from the physical model M1 and the correction value output from the correction model M2 as the received power of the arbitrary communication device.

For example, as illustrated in FIG. 3, when there are a plurality of communication devices for which received power is to be estimated, the information processing apparatus 100 sets a set of position information of one base station and position information of one communication device as input data, and inputs the set to the propagation model M3. By repeatedly executing the above-described processing while changing the target communication device, the information processing apparatus 100 calculates the received power of each communication device and calculates the estimation result 7. The information processing apparatus 100 may collectively set the position information of the base station and the position information of the plurality of communication devices as the input data and calculate the estimation result 7.

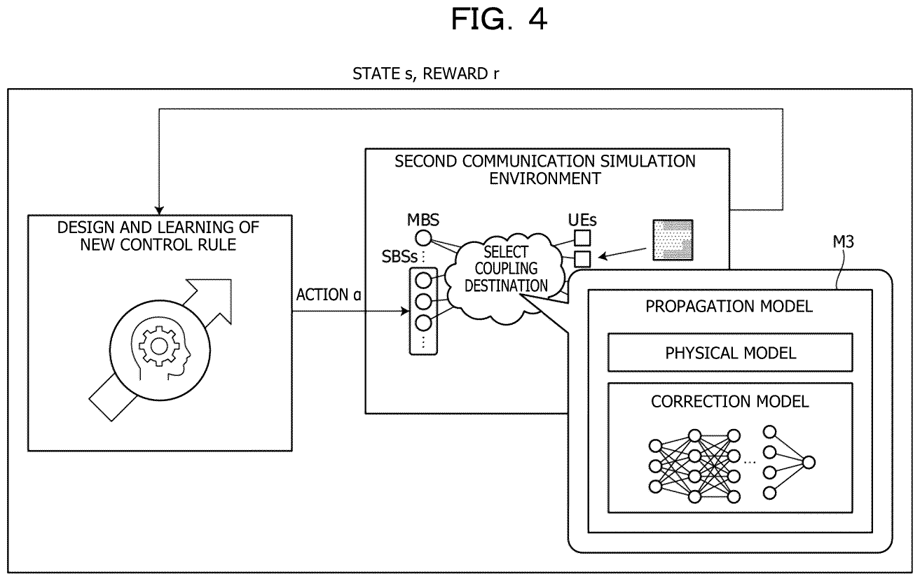

Next, an example of the processing related to design and learning of a control rule will be described. FIG. 4 is a diagram for describing the processing related to the design and learning of the control rule. In the example illustrated in FIG. 4, the information processing apparatus 100 constructs a new communication simulation environment by using the propagation model M3, and derives a new control rule for the network operation. Hereinafter, the new communication simulation environment will be referred to as a “second communication simulation environment”.

While the received power of the communication device is estimated by using only the physical model M1 in the first communication simulation environment illustrated in FIG. 2, the received power of the communication device is estimated by using the propagation model M3 in the second communication simulation environment. In the propagation model M3, the estimated value of the physical model M1 is corrected using the correction value of the correction model M2, so that estimation accuracy of the received power of the communication device is improved.

By executing reinforcement learning in the second communication simulation environment, the information processing apparatus 100 learns a new control rule for performing wave suspension control of the base station. For example, the information processing apparatus 100 generates an action α based on a state s and a control rule of the second communication simulation environment, performs the wave suspension control of the base station, and acquires a state s and a reward r after the wave suspension control. The control rule is a control rule for determining the action α based on the state s.

The state s includes a time, a traffic amount of each grid, a load of the base station, and the like. The grid is a grid obtained by dividing a target area into individual predetermined regions. With the action α, the active mode or the sleep mode is set in the RU of each base station. The reward r includes a total sum of reduction amounts in power consumption of each base station.

Based on the propagation model M3, the information processing apparatus 100 estimates received power of each communication device, and based on the estimation result, estimates power consumption of a corresponding base station. In the following description, power consumed when the RU of the base station is in the active mode or the sleep mode is simply referred to as “power consumption”.

By using, for example, a relationship in which a base station to which each communication device is coupled is determined in accordance with a magnitude of received power of a radio wave transmitted from each base station, and power consumption of the base station as the corresponding coupling destination is larger as a total sum of traffic request amounts of each coupled communication device is larger, the information processing apparatus 100 estimates the power consumption. By summing up the power consumption of each base station, the information processing apparatus 100 calculates a total sum of the power consumption of each base station. By subtracting the total sum of the power consumption of each base station after the wave suspension control is performed by the action α from the total sum of the power consumption of each base station before the wave suspension control is performed by the action α, the information processing apparatus 100 calculates the reward r.

While changing the control rule such that the reward r is maximized, the information processing apparatus 100 repeatedly executes the processing of generating the action α from the state s (executes reinforcement learning). By applying a new control rule obtained after the reinforcement learning to the actual operation environment, the information processing apparatus 100 performs the wave suspension control of the base station. For example, the actual operation environment is the area 5 illustrated in FIG. 1.

The information processing apparatus 100 repeatedly executes the processing of collecting the actually measured data, the processing of performing learning of the correction model, the processing of creating the propagation model, and the processing related to the design and learning of the control rule, described above.

While the information processing apparatus 100 derives the control rule by using the reinforcement learning in the description of FIG. 4, the disclosure is not limited thereto. For example, the information processing apparatus 100 may derive the new control rule by using mathematical optimization, model estimation control, or the like. When deriving the control rule, the information processing apparatus 100 may perform transfer learning by using parameters of the previously derived control rule.

While the information processing apparatus 100 uses the total sum of reduction amounts in the power consumption of each base station as the reward for performing the reinforcement learning, the disclosure is not limited thereto. For example, received power of each communication device or a signal-to-interference-plus-noise ratio (SINR) of each communication device may be used as the reward.

As described above, when estimating the received power of the communication device, the information processing apparatus 100 according to the present embodiment performs learning of the correction model M2 that generates the correction value A for correcting the estimated value P′ of the physical model M1, and uses the propagation model M3 including the physical model M1 and the correction model M2. Consequently, it is possible to more accurately estimate the received power of the communication device than in a case where the received power of the communication device is estimated by the physical model M1 alone or a case where the received power of the communication device is estimated by the estimation model learned by machine learning alone.

While changing the control rule such that the reward r is maximized in the second communication simulation environment, the information processing apparatus 100 repeatedly executes the processing of generating the action α from the state s (executes reinforcement learning). Consequently, it is possible to avoid occurrence of a constraint violation or performance deterioration in the network operation due to selection of an unfavorable (non-optimal) action during learning and derive an appropriate control rule. When the control rule learned in the second communication simulation environment is introduced into the actual operation environment, the same performance as that at the time of learning may be achieved. By repeating the above-described processing, it is possible to reduce a number of man-hours for adjusting and relearning desired hyper parameters even in a case where the performance is not achieved.

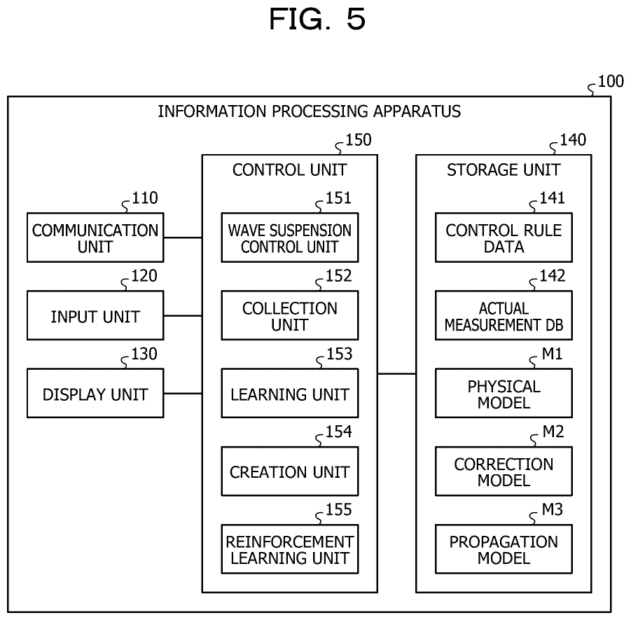

Next, a configuration example of the information processing apparatus 100 that executes the processing described above will be described. FIG. 5 is a functional block diagram illustrating a configuration of the information processing apparatus according to the present embodiment. As illustrated in FIG. 5, this information processing apparatus 100 includes a communication unit 110, an input unit 120, a display unit 130, a storage unit 140, and a control unit 150.

The communication unit 110 executes data communication with the base station, the communication device, an external device, and the like via the network. The communication unit 110 is a network interface card (NIC) or the like.

The input unit 120 is an input device that inputs various types of information to the control unit 150 of the information processing apparatus 100. For example, the input unit 120 corresponds to a keyboard, a mouse, a touch panel, or the like.

The display unit 130 is a display device that displays the information output from the control unit 150.

The storage unit 140 includes control rule data 141, the actual measurement DB 142, the physical model M1, the correction model M2, and the propagation model M3. The storage unit 140 is a memory or the like.

The control rule data 141 is information on the control rule described above. Based on the control rule data 141, the information processing apparatus 100 performs the wave suspension control of the base station.

The actual measurement DB 142 stores the actually measured data that is collected by the information processing apparatus 100. Other descriptions related to the actually measured data and the actual measurement DB 142 are the same as those described above.

The physical model M1 is a model that estimates the received power of the communication device that receives the radio wave of the base station based on the distance attenuation expression or the like of the radio wave in the first communication simulation environment set in advance. Other descriptions related to the physical model M1 are the same as those described above.

The correction model M2 is a model (NN) that receives the input data 142a as the input and outputs the correction value A. Other descriptions related to the correction model M2 are the same as those described above.

The propagation model M3 is a model obtained by combining the physical model M1 and the trained correction model M2 described above. Other descriptions related to the propagation model M3 are the same as those described above.

The control unit 150 includes a wave suspension control unit 151, a collection unit 152, a learning unit 153, a creation unit 154, and a reinforcement learning unit 155. The control unit 150 is a central processing unit (CPU), a graphics processing unit (GPU), or the like.

Based on the control rule data 141, the wave suspension control unit 151 controls the RU of each base station included in the area serving as the actual operation environment. In the following description, the description will be given on the assumption that the area serving as the actual operation environment is referred to as an “area 5”.

By using the communication unit 110, for example, the wave suspension control unit 151 communicates with the base station included in the area 5 and specifies a state of the area 5. The state includes a time, a traffic amount of each grid, a load of the base station, and the like. Based on the state of the area 5 and the control rule data 141 (latest control rule), the wave suspension control unit 151 generates a control signal for setting the RU of the base station included in the area 5 to the active mode or the sleep mode, and transmits the control signal to the base station. The wave suspension control unit 151 repeatedly executes this processing at predetermined time intervals.

By using the communication unit 110, the collection unit 152 communicates with the base station and the communication device included in the area 5 and collects actually measured data. The collection unit 152 registers the collected actually measured data in the actual measurement DB 142. The collection unit 152 repeatedly executes this processing at predetermined time intervals for a certain period of time.

Description of processing other than the processing in which the collection unit 152 collects the actually measured data corresponds to the description of the processing performed in FIG. 1.

Based on the actual measurement DB 142 and the physical model M1, the learning unit 153 executes learning (machine learning) of the correction model M2. Description of processing in which the learning unit 153 performs learning of the correction model M2 corresponds to the description of the processing performed in FIG. 2.

By combining the physical model M1 and the trained correction model M2, the creation unit 154 generates the propagation model M3. Description related to the propagation model M3 is the same as the description related to the propagation model M3 described with reference to FIG. 3.

By using the propagation model M3, the reinforcement learning unit 155 constructs a new communication simulation environment (second communication simulation environment) and executes reinforcement learning of the control rule, thereby deriving a new control rule for the network operation. By using the derived control rule, the reinforcement learning unit 155 updates the control rule data 141.

Description of the processing in which the reinforcement learning unit 155 derives the control rule is the same as the description of the processing related to the design and learning of the control rule described with reference to FIG. 4.

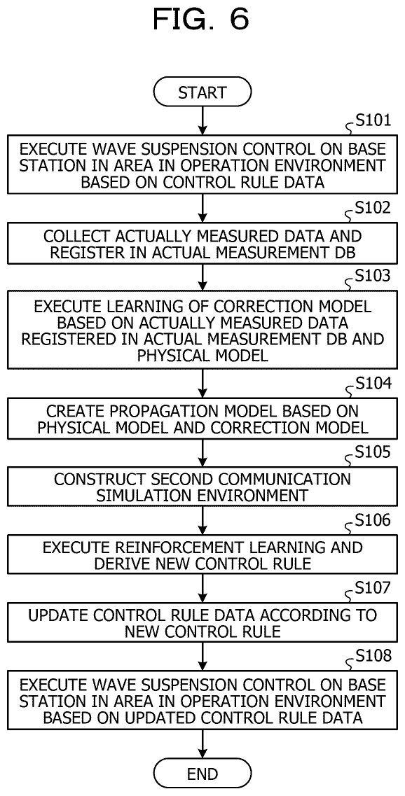

Next, an example of a processing procedure of the information processing apparatus 100 according to the present embodiment will be described. FIG. 6 is a flowchart illustrating the processing procedure of the information processing apparatus according to the present embodiment. As illustrated in FIG. 6, the wave suspension control unit 151 of the information processing apparatus 100 executes wave suspension control of the base station in the area corresponding to the actual operation environment based on the control rule data 141 (step S101).

By operating the network for a certain period of time, the collection unit 152 of the information processing apparatus 100 communicates with the base station and the communication device in the area corresponding to the actual operation environment, collects actually measured data, and registers the actually measured data in the actual measurement DB 142 (step S102).

Based on the actually measured data registered in the actual measurement DB 142 and the physical model M1, the learning unit 153 of the information processing apparatus 100 executes learning of the correction model M2 (step S103). Based on the physical model M1 and the correction model M2, the creation unit 154 of the information processing apparatus 100 creates the propagation model M3 (step S104).

By incorporating the propagation model M3 into the first communication simulation environment, the information processing apparatus 100 constructs a second communication simulation environment (step S105).

By executing reinforcement learning in the second communication simulation environment, the reinforcement learning unit 155 of the information processing apparatus 100 derives a new control rule for performing wave suspension control of the base station (step S106). By using the new control rule, the reinforcement learning unit 155 updates the control rule data 141 (step S107).

Based on the updated control rule data 141, the wave suspension control unit 151 executes the wave suspension control of the base station in the area corresponding to the actual operation environment (step S108).

Next, a specific example of a target area and an example of an estimation result of received power at each point by the propagation model M3 will be described.

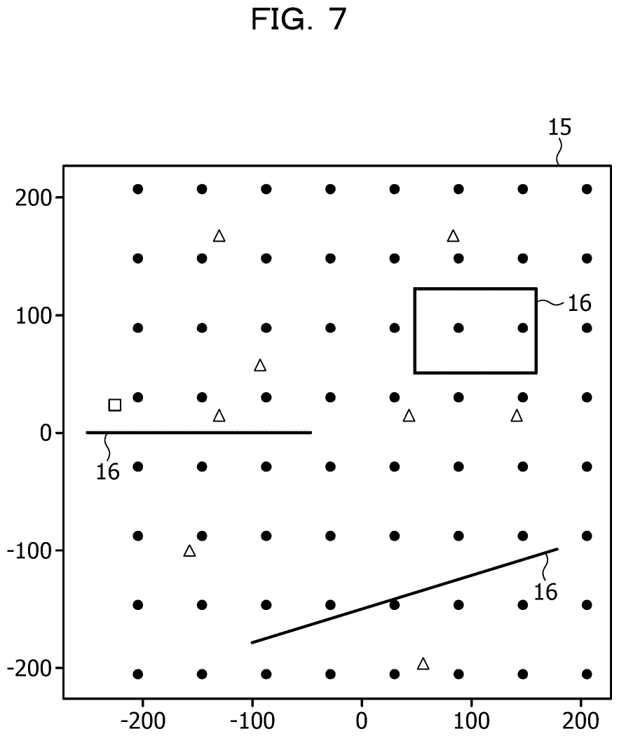

FIG. 7 is a diagram illustrating the target area. In the example illustrated in FIG. 7, an example in which one first base station (macro cell base station: MBS), a plurality of (for example, 11) second base stations (small cell base station: SBS), and a plurality of (for example, 64) communication devices (UEs) are included in a target area 15 is illustrated. The first base station is indicated by a square (□). The second base stations are indicated by triangles (Δ). For example, second base stations whose positions overlap each other may be indicated by a single triangle. The communication devices are indicated by circles (●). Six shields 16 are set in the target area 15. It is assumed that an influence of the shields 16 in a radio wave environment is unknown.

Learning conditions of the correction model M2 using the DNN by the learning unit 153 are set to the following conditions (1) to (3).

Condition (1): Position information of a base station and position information of a communication device are set as input data of learning data (actually measured data). Received power of the communication device is set as output data.

Condition (2): A model structure and a number of parameters are as follows. A number of hierarchies is set to four. A hierarchy includes an input layer, two intermediate layers, and an output layer. A number of neurons in the intermediate layer is set to 64. An activation function of the intermediate layer is set as a ReLU function.

Condition (3): With regard to a learning algorithm, an optimization technique is “Adam”, and a loss function is “mean absolute error”.

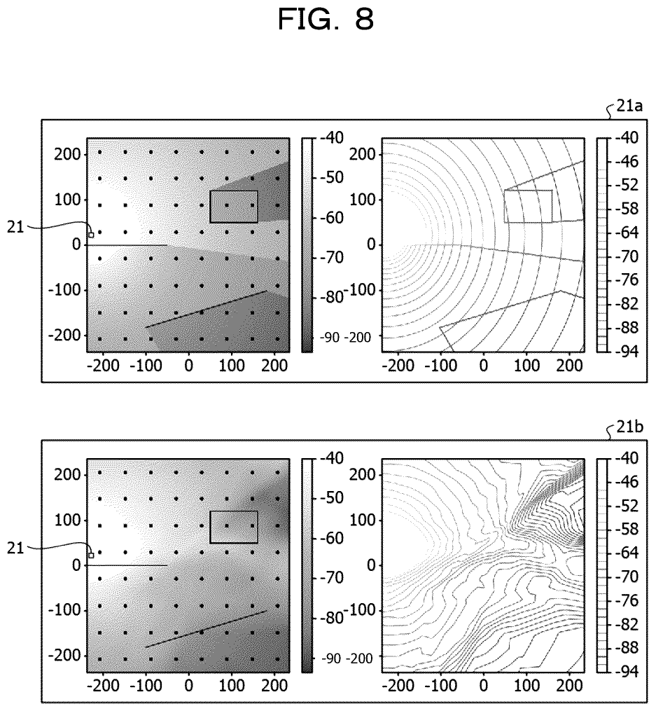

FIG. 8 to FIG. 11 are diagrams illustrating comparison results between estimated values by the propagation model and theoretical values. The theoretical value is a correct value.

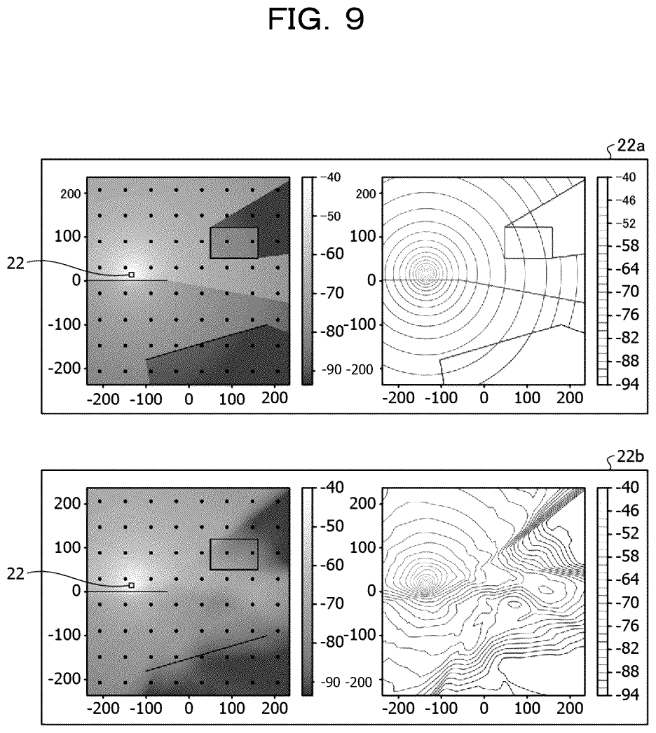

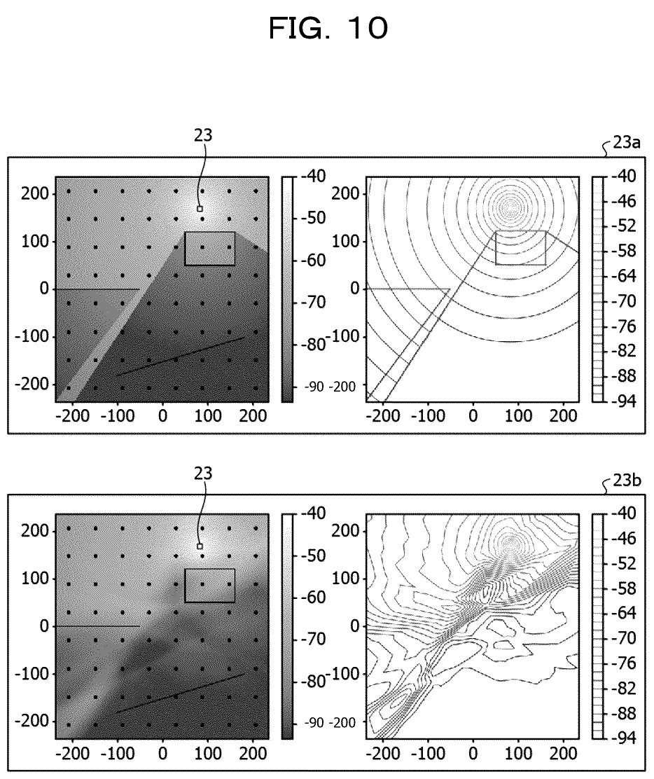

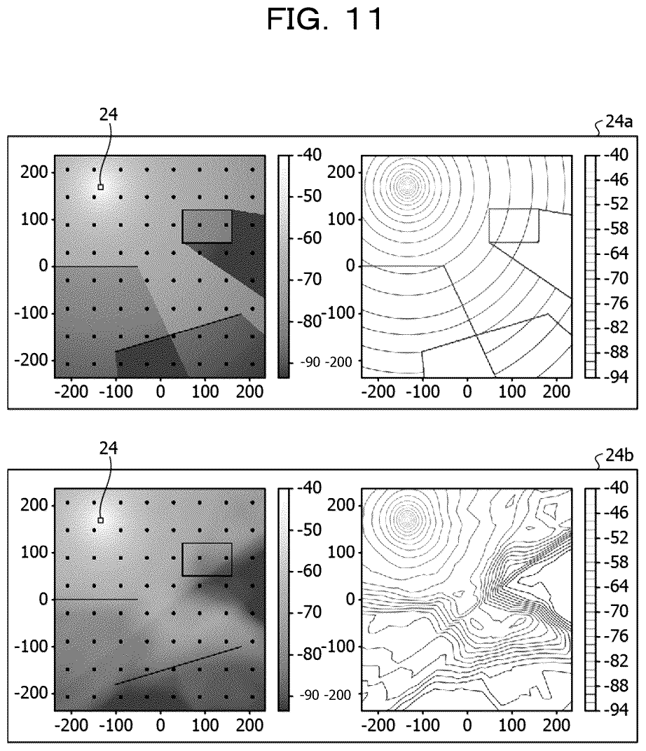

FIG. 8 illustrates a theoretical value 21a and an estimated value 21b of received power of each communication device (point) in a case where a first base station 21 transmits a radio wave. FIG. 9 illustrates a theoretical value 22a and an estimated value 22b of received power of each communication device (point) in a case where a second base station 22 transmits a radio wave. FIG. 10 illustrates a theoretical value 23a and an estimated value 23b of received power of each communication device (point) in a case where a second base station 23 transmits a radio wave. FIG. 11 illustrates a theoretical value 24a and an estimated value 24b of received power of each communication device (point) in a case where a second base station 24 transmits a radio wave. Comparison results between estimated values and theoretical values of received power of each communication device in a case where other base stations transmit radio waves are not illustrated.

With reference to the comparison results between the estimated values and the theoretical values illustrated in FIGS. 8 to 11, it may be seen that the estimated values estimated by the propagation model M3 are close to the respective theoretical values. By using the propagation model M3, the received power of the communication device may be accurately estimated.

Next, a verification result of the wave suspension control on the base station will be described. When the verification is performed, the wave suspension control on the base station was executed for ten days for the target area 15 illustrated in FIG. 7 based on the control rule derived by the information processing apparatus 100. Traffic data acquisition and switching of the active/sleep of the RU of each base station were executed every 30 minutes. When the wave suspension control is executed, it is assumed that, in a case where a communication device that is not couplable to any of the base stations occurs in the target area 15, the RUs of all the base stations are set to active by a fail-safe function, and recoupling is performed.

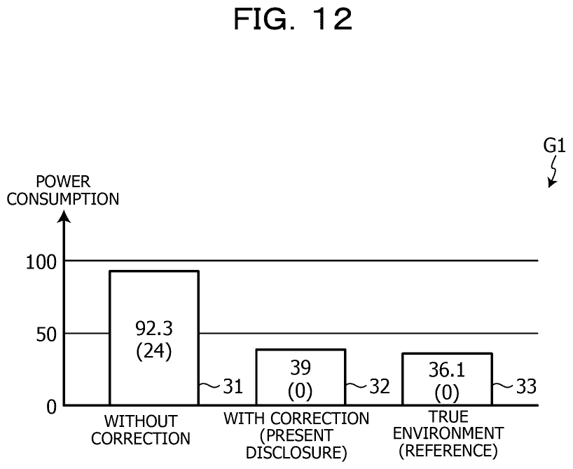

FIG. 12 is a diagram illustrating a comparison result of average power consumption of the base station. A vertical axis of a graph G1 is an axis corresponding to the power consumption of the base station. A bar graph 31 indicates a control result (average power consumption) according to the control rule learned in the first communication simulation environment. A bar graph 32 indicates a control result (average power consumption) according to the control rule learned in the second communication simulation environment. For reference, a bar graph 33 indicates a control result (average power consumption) of a control rule learned in a communication simulation in which a true radio wave environment is simulated as a known environment.

In the example illustrated in FIG. 12, the fail-safe occurs 24 times with the control according to the control rule learned in the first communication simulation environment. By contrast, with the control according to the control rule learned in the second communication simulation environment, the fail-safe does not occur even once. Consequently, the average power consumption of the base station may be reduced in the second communication simulation environment as compared with the first communication simulation environment. It is possible to avoid the occurrence of a communication device without a coupling destination at the time of executing the wave suspension control due to the difference in a radio wave environment between the simulation environment at the time of deriving the control rule and the actual operation environment, and to reduce the number of man-hours for rederiving the control rule.

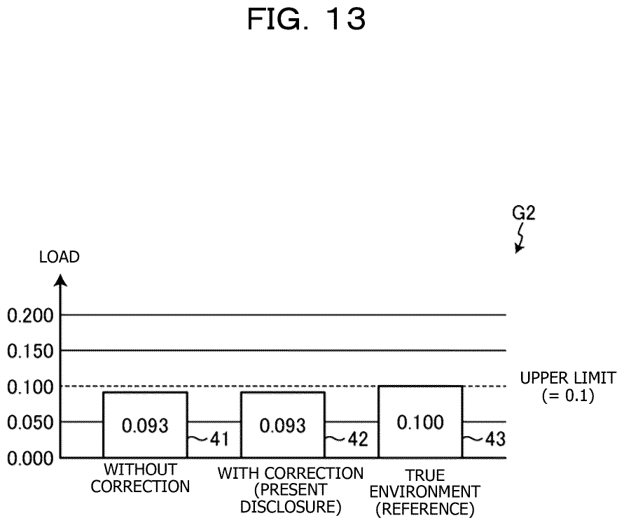

FIG. 13 is a diagram illustrating a comparison result of maximum loads of the base station. A vertical axis of a graph G2 is an axis corresponding to a load of the base station. A bar graph 41 indicates a control result (maximum load) according to the control rule learned in the first communication simulation environment. A bar graph 42 indicates a control result (maximum load) according to the control rule learned in the second communication simulation environment. For reference, a bar graph 43 indicates a control result (maximum load) of a control rule learned in a communication simulation in which a true radio wave environment is simulated as a known environment.

As illustrated in FIG. 13, the maximum loads of the base station are substantially the same under any condition.

Next, effects of the information processing apparatus 100 according to the present embodiment will be described. When estimating the received power of the communication device, the information processing apparatus 100 performs learning of the correction model M2 that generates the correction value A for correcting the estimated value P′ of the physical model M1, and uses the propagation model M3 including the physical model M1 and the correction model M2. Consequently, it is possible to more accurately estimate the received power of the communication device than in a case where the received power of the communication device is estimated by the physical model M1 alone or a case where the received power of the communication device is estimated by the estimation model learned by machine learning alone.

While changing the control rule such that the reward r is maximized in the second communication simulation environment, the information processing apparatus 100 repeatedly executes processing of generating the action α from the state s (executes reinforcement learning). Consequently, it is possible to avoid occurrence of a constraint violation or performance deterioration in the network operation due to selection of an unfavorable (non-optimal) action during learning and derive an efficient control rule. When the control rule learned in the second communication simulation environment is introduced into the actual operation environment, the same performance as that at the time of learning may be achieved. By repeating the above-described processing, it is possible to reduce the number of man-hours for adjusting and relearning desired hyper parameters or the like even in a case where the performance is not achieved.

Based on the difference between the estimated value P′ and the actually measured value P, the information processing apparatus 100 performs learning of the correction model M2. With this, it is possible to generate the correction model M2 capable of correcting the output result of the physical model M1.

By combining the physical model M1 and the correction model M2, the information processing apparatus 100 creates the propagation model M3. By using the propagation model M3, the received power of the communication device may be accurately estimated.

When training of the correction model M2 is executed, the information processing apparatus 100 may further use, as the input data 142a, the height at which the base station is installed, the power consumption (transmission power) taken for the base station to transmit the radio wave, the frequency of the radio wave, the height of the communication device, and the like. Consequently, the received power of the communication device may be accurately estimated.

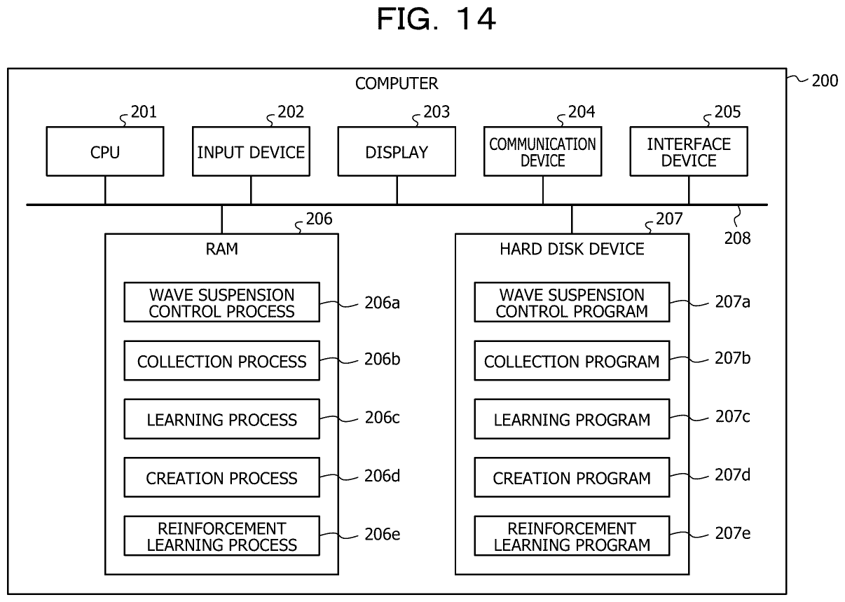

Next, an example of a hardware configuration of a computer that implements same functions as those of the information processing apparatus 100 described above will be described. FIG. 14 is a diagram illustrating an example of a hardware configuration of a computer that implements the same functions as those of the information processing apparatus according to the present embodiment.

As illustrated in FIG. 14, a computer 200 includes a CPU 201 that executes various types of arithmetic processing, an input device 202 that receives input of data from a user, and a display 203. The computer 200 includes a communication device 204 that exchanges data with an external device or the like via a wired or wireless network, and an interface device 205. The computer 200 includes a random-access memory (RAM) 206 that temporarily stores various types of information, and a hard disk device 207. Each of the CPU 201 to the hard disk device 207 is coupled to a bus 208.

The hard disk device 207 includes a wave suspension control program 207a, a collection program 207b, a learning program 207c, a creation program 207d, and a reinforcement learning program 207e. The CPU 201 reads each of the programs 207a to 207e and loads each of the programs 207a to 207e into the RAM 206.

The wave suspension control program 207a functions as a wave suspension control process 206a. The collection program 207b functions as a collection process 206b. The learning program 207c functions as a learning process 206c. The creation program 207d functions as a creation process 206d. The reinforcement learning program 207e functions as a reinforcement learning process 206e.

Processing of the wave suspension control process 206a corresponds to the processing of the wave suspension control unit 151. Processing of the collection process 206b corresponds to the processing of the collection unit 152. Processing of the learning process 206c corresponds to the processing of the learning unit 153. Processing of the creation process 206d corresponds to the processing of the creation unit 154. Processing of the reinforcement learning process 206e corresponds to the processing of the reinforcement learning unit 155.

Each of the programs 207a to 207e is not necessarily stored in the hard disk device 207 from the beginning. For example, each of the programs 207a to 207e may be stored in a “portable physical medium”, such as a flexible disk (FD), a compact disc read-only memory (CD-ROM), a Digital Versatile Disc (DVD), a magneto-optical disk, or an integrated circuit (IC) card, to be inserted into the computer 200. The computer 200 may read and execute each of the programs 207a to 207e.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a learning program for causing a computer to execute a process comprising:
calculating, by using a first model that estimates a value of received power of a radio wave received by a communication device from a base station based on position information of the base station and position information of the communication device, an estimated value of the received power of the radio wave; and
training a second model that outputs a correction value for correcting the estimated value of the first model based on an actually measured value of the received power of the communication device in an operation environment using the first model, and the estimated value.

2. The non-transitory computer-readable recording medium according to claim 1, wherein in the training, the second model is trained based on a difference between the actually measured value and the estimated value.

3. The non-transitory computer-readable recording medium according to claim 2, wherein
the second model is a model that outputs the correction value in a case where the position information of the base station and the position information of the communication device is input, and
the non-transitory computer-readable recording medium further causes the computer to execute a process of generating a third model that calculates the estimated value of the received power of the communication device based on the correction value and the estimated value calculated based on the position information of the base station, the position information of the communication device, and the first model.

4. The non-transitory computer-readable recording medium according to claim 3, further causing the computer to execute a process of
by repeatedly executing processing of specifying an action based on a state of an area of a communication simulation environment and a control rule, performing wave suspension control of a base station included in the communication simulation environment based on the specified action, and specifying a reward based on the estimated value of the received power of the communication device calculated based on information on the base station and the communication device included in the area after the wave suspension control is performed and the third model,
performing learning of updating the control rule such that the reward is maximized.

5. The non-transitory computer-readable recording medium according to claim 4, further causing the computer to execute a process of performing the wave suspension control on the base station based on the updated control rule.

6. The non-transitory computer-readable recording medium according to claim 1, wherein in the calculating of the estimated value, the estimated value of the received power of the radio wave is calculated by further using a height at which the base station is installed, power consumption when the base station transmits the radio wave, a frequency of the radio wave, and a height at which the communication device is installed.

7. A learning method for causing a computer to execute a process comprising:
calculating, by using a first model that estimates a value of received power of a radio wave received by a communication device from a base station based on position information of the base station and position information of the communication device, an estimated value of the received power of the radio wave; and
training a second model that outputs a correction value for correcting the estimated value of the first model based on an actually measured value of the received power of the communication device in an operation environment using the first model, and the estimated value.

8. The learning method according to claim 7, wherein in the training, the second model is trained based on a difference between the actually measured value and the estimated value.

9. The learning method according to claim 8, wherein
the second model is a model that outputs the correction value in a case where the position information of the base station and the position information of the communication device is input, and
the non-transitory computer-readable recording medium further causes the computer to execute a process of generating a third model that calculates the estimated value of the received power of the communication device based on the correction value and the estimated value calculated based on the position information of the base station, the position information of the communication device, and the first model.

10. The learning method according to claim 9, further causing the computer to execute a process of
by repeatedly executing processing of specifying an action based on a state of an area of a communication simulation environment and a control rule, performing wave suspension control of a base station included in the communication simulation environment based on the specified action, and specifying a reward based on the estimated value of the received power of the communication device calculated based on information on the base station and the communication device included in the area after the wave suspension control is performed and the third model,
performing learning of updating the control rule such that the reward is maximized.

11. The learning method according to claim 10, further causing the computer to execute a process of performing the wave suspension control on the base station based on the updated control rule.

12. The learning method according to claim 7, wherein in the calculating of the estimated value, the estimated value of the received power of the radio wave is calculated by further using a height at which the base station is installed, power consumption when the base station transmits the radio wave, a frequency of the radio wave, and a height at which the communication device is installed.

13. An information processing apparatus comprising:
a memory; and
a processor coupled to the memory and configured to:
calculate, by using a first model that estimates a value of received power of a radio wave received by a communication device from a base station based on position information of the base station and position information of the communication device, an estimated value of the received power of the radio wave; and
train a second model that outputs a correction value for correcting the estimated value of the first model based on an actually measured value of the received power of the communication device in an operation environment using the first model, and the estimated value.

14. The information processing apparatus according to claim 13, wherein the second model is trained based on a difference between the actually measured value and the estimated value.

15. The information processing apparatus according to claim 14, wherein
the second model is a model that outputs the correction value in a case where the position information of the base station and the position information of the communication device is input, and
the processor further executes a process of generating a third model that calculates the estimated value of the received power of the communication device based on the correction value and the estimated value calculated based on the position information of the base station, the position information of the communication device, and the first model.

16. The information processing apparatus according to claim 15, wherein the processor further executes a process of
by repeatedly executing processing of specifying an action based on a state of an area of a communication simulation environment and a control rule, performing wave suspension control of a base station included in the communication simulation environment based on the specified action, and specifying a reward based on the estimated value of the received power of the communication device calculated based on information on the base station and the communication device included in the area after the wave suspension control is performed and the third model,
performing learning of updating the control rule such that the reward is maximized.

17. The information processing apparatus according to claim 16, wherein the processor executes a process of performing the wave suspension control on the base station based on the updated control rule.

18. The information processing apparatus according to claim 13, wherein the estimated value of the received power of the radio wave is calculated by further using a height at which the base station is installed, power consumption when the base station transmits the radio wave, a frequency of the radio wave, and a height at which the communication device is installed.
